(19) United States
(12) Patent Application Publication
(10) Pub. No.: US 2021/0352514 A1
(43) Pub. Date: Nov. 11, 2021

(54) Power Efficient Processing of Down Link Traffic Using Multiple Parallel Flows

(71) Applicant: QUALCOMM Incorporated, San Diego, CA (US)

(72) Inventors: Vamsi DOKKU, San Diego, CA (US); Subash Abhinov KASIVISWANATHAN, Erie, CO (US); Sitaramanjaneyulu KANAMARLAPUDI, San Diego, CA (US)

(21) Appl. No.: 16/869,355

(22) Filed: May 7, 2020

(51) Int. Cl. H04W 28/02

(52) U.S. Cl. CPC H04W 28/0205; H04W 28/06

(57) ABSTRACT

Methods executed by a processor element for providing data packets from a modem to an application processor in a computing device are disclosed. Exemplary implementations may reorder packets received by the modem from a plurality of parallel flows so as to provide to the application processor batches of packets from individual flows within the plurality of parallel flows.

### BACKGROUND

Long Term Evolution (LTE), Fifth Generation (5G) new radio (NR)(5GNR), and other recently developed communication technologies allow user equipment to communicate information at data rates (e.g., in terms of Gigabits per second, etc.) that are significantly greater than what was available just a few years ago. Such improvements in data rates have enabled the growth of data intensive uses of mobile wireless devices, including high definition (HD) streaming media and mobile gaming, to name just two examples.

To accommodate data intensive applications wireless networks are increasingly relying on transmitting data packets to wireless devices over multiple parallel flows. To accommodate this trend, which is expected to continue and expand, wireless network providers are requiring that wireless devices be capable of achieving download throughput requirements with more than 10 parallel streams or flows, with each carrying the same amount of data.

### SUMMARY

Various aspects include methods executed by a processor or processing element for providing data packets from a modem to an application processor in a computing device. Various aspects may include reordering packets received by the modem from a plurality of parallel flows so as to provide to the application processor batches of packets from individual flows within the plurality of parallel flows. Various aspects may include reordering packets received by the modem from a plurality of parallel flows so as to provide to the application processor batches of packets from individual flows within the plurality of parallel flows.

Various aspects may include reordering packets received by the modem from a plurality of parallel flows so as to provide to the application processor batches of packets from individual flows within the plurality of parallel flows.

In some aspects, reordering packets received by the modem from a plurality of parallel flows so as to provide to the application processor batches of packets from individual flows within the plurality of parallel flows may include receiving data packets in the plurality of parallel flows interleaved in time, reordering the received data packets into batches of data packets from individual flows in a cache memory, and providing the batches of data packets to the application processor one flow at a time.

In some aspects, reordering packets received by the modem from a plurality of parallel flows so as to provide to the application processor batches of packets from individual flows within the plurality of parallel flows may include receiving data packets in the plurality of parallel flows, reordering the received data packets to form batches of data packets from one or more selected flows among the plurality of parallel flows, and providing the batches of data packets from the one or more selected flows to the application processor and providing data packets from one or more remaining flows in the plurality of parallel flows to the application processor in received order.

Some aspects may further include receiving from the application processor an identification of one or more flows from which data packets should be provided in batches, in which reordering packets received by the modem from a plurality of parallel flows so as to provide to the application processor batches of packets from individual flows within the plurality of parallel flows may include caching data packets received from the identified one or more flows to form batches of data packets for each of the identified one or more flows, and providing the batches of data packets for each of the identified one or more flows to the application processor.

Some aspects may further include determining whether a criterion for releasing the one or more flows identified for special processing is satisfied, in which wherein providing the batches of data packets for each of the identified one or more flows to the application processor may include providing the batches of data packets for each of the identified one or more flows to the application processor in response to determining that the criterion for releasing the batches of data packets is satisfied. In such aspects, the criterion may include one or more of a criterion received from the application processor, a limit on bytes of data from the identified one or more flows stored in a cache memory, a limit on a number of data packets from the identified one or more flows stored in the cache memory, or a limit time that data packets from the identified one or more flows have been stored in the cache memory.

Some aspects may further include evaluating data received in the modem to identify one or more flows for special processing, in which reordering packets received by the modem from a plurality of parallel flows so as to provide to the application processor batches of packets from individual flows within the plurality of parallel flows may include caching data packets received from the one or more flows identified for special processing to form batches of data packets for each of the one or more flows identified for special processing, and providing the batches of data packets for each of the one or more flows identified for special processing to the application processor.

Some aspects may further include determining whether a criterion for releasing the one or more flows identified for special processing is satisfied, in which wherein providing the batches of data packets for each of the one or more flows identified for special processing to the application processor may include providing the batches of data packets for each of the one or more flows identified for special processing to the application processor in response to determining that the criterion for releasing the batches of data packets is satisfied. In such aspects, the criterion may include one or more of a limit on bytes of data from the identified one or more flows stored in a cache memory, a limit on a number of data packets from the identified one or more flows stored in the cache memory, or a limit time that data packets from the identified one or more flows have been stored in the cache memory.

Further aspects may include a computing device having a processor or processing element configured to perform operations of any of the methods summarized above. Further aspects include a modem including a processor or processing element configured to perform operations of any of the methods summarized above. Further aspects include a processing element that may be a component of a modem or coupled between a modem and an application processor and that is configured to perform operations of any of the methods summarized above. Further aspects include a computing device having means for performing functions of any of the methods summarized above. Further aspects include a system on chip for use in a computing device that includes a processor or processing element configured to perform one or more operations of any of the methods summarized above. Further aspects include a system in a package that includes two systems on chip for use in a computing device that includes a processor or processing element configured to perform one or more operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a system block diagram illustrating an example communication system suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4A is a notional block diagram illustrating the presentation of data packets received by a modem from a plurality of flows to an application processor in received order in accordance with conventional methods.

FIG. 4B is a notional block diagram illustrating the presentation of data packets received by a modem from a plurality of flows to an application processor in batches associated with individual flows within the plurality of flows in accordance with various embodiments.

FIG. 5 is a component block diagram illustrating a system configured executed by a processor element for providing data packets from a modem to an application processor in a computing device in accordance with various embodiments.

FIGS. 6A, 6B, 6C, 6D, 6E, 6F, and 6G are process flow diagrams illustrating various methods that may be executed by a processor element for providing data packets from a modem or modems to an application processor in a computing device in accordance with various embodiments.

FIG. 7 is a component block diagram of a wireless computing device suitable for use with various embodiments.

FIG. 8 is a component block diagram of a mobile computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods that may be executed by a processor element of a computing device for improving the efficiency of processing data packets received from a plurality of parallel data flows. Various aspects may include providing data packets from a modem to an application processor in the computing device by reordering packets received by the modem from a plurality of parallel flows so as to provide to the application processor batches of packets from individual flows within the plurality of parallel flows. As a result, data packets that are received from the plurality of flows interleaved in time may be provided to the application processor in batches of packets interleaved among the flows. In some embodiments, reordering of data packets may be applied to one or more flows selected from among the plurality of flows. In some embodiments, the application processor may inform the modem or processor element of the selected one or more flows. In some embodiments, the modem or processor element may select one or more flows based on observations of packet traffic within the plurality of flows.

The term “computing device” is used herein to refer to any one or all of cellular telephones, smartphones, portable computing devices, personal or mobile multi-media players, laptop computers, tablet computers, smartbooks, ultrabooks, wireless electronic mail receivers, multimedia Internet-enabled cellular telephones, medical devices and equipment, biometric sensors/devices, entertainment devices (e.g., wireless gaming controllers, music and video players, satellite radios, etc.), industrial manufacturing equipment, wireless communication elements within autonomous and semiautonomous vehicles, wireless computing devices affixed to or incorporated into various mobile platforms, and similar electronic devices that include a memory, wireless communication components configured to receive and process a plurality of parallel data flows, and an application processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. An SIP may also include multiple independent SOCs coupled together via high speed communication circuitry and packaged in close proximity, such as on a single motherboard or in a single wireless device. The proximity of the SOCs facilitates high speed communications and the sharing of memory and resources.

The term “flow” is used herein to refer to a source of data packets as well as to the stream of data packets from that source. A flow may be set of packets that can uniquely identified by either a 5-tuple (source IP address, source TCP/UDP port, destination IP address, destination TCP/UDP port and IP protocol) or a 3-tuple (source IP address, destination IP address, IP protocol). A flow may encompass a stream of data packets received from a given socket established in a wired or wireless connection. A flow may also encompass a stream of data received from a particular wired or wireless connection, such as a wireless communication link with a 5G wireless network via a 5G transceiver, a millimeter wave (mmWave) wireless communication link with a 5G wireless network via a mmWave transceiver, and/or a WiFi communication link to a wireless local area network (WLAN) via a WiFi transceiver, etc.

The term “parallel flows” is used herein to refer to multiple data packet flows that are established simultaneously enabling data packets from any of the parallel flows to be received by one or more modems independent of other flows.

To accommodate the ever-growing demand for data intensive services and applications, network carriers are imposing requirements on wireless computing devices to accommodate more than 10 parallel flows of data packets.

To enable more efficient processing of data received over multiple parallel flows, various embodiments include methods and processor elements within wireless computing devices for providing data packets from one or more modems to an application processor in batches of data packets for some or all of the flows. Providing data packets from a given flow in batches enables the application processor to operate more efficiently, including using less power, compared to providing data packets from multiple parallel flows in the order the data packets are received. Thus, various embodiments include reordering packets received by the modem or modems from a plurality of parallel flows so as to provide to the application processor batches of packets from individual flows within the plurality of parallel flows. In some embodiments, this may include the computing device receiving data packets in the plurality of parallel flows interleaved in time, and reordering the received data packets into batches of data packets from individual flows in a cache memory so that batches of data packets can be provided to the application processor one flow at a time.

In some embodiments, the reordering of data packets into batches for delivery to the application processor may be applied to some but not all of the parallel flows. In such embodiments, data packets from the non-selected parallel flows may be provided to the application processor or in the order of reception. In particular, reordering of received data packets to form batches of data packets may be perform for one or more selected flows among the plurality of parallel flows. In some embodiments, the application processor may signal the modem or modems to identify those flows for which data packet reordering into batches should be performed. In some embodiments, the modem or modems may identify the one or more data flows that should be selected for reordering of data packets into batches by observing data transmission characteristics (e.g., data rate) of the parallel flows. Some non-limiting examples of criteria that the modem or modems may use for making this determination include data rates of each flow, type of service associated with each flow, and latency associated with each flow.

In various embodiments, reordering of data packets may be accomplished by caching data packets in a cache memory so that packets received over a period of time can be accumulated and organized or accessed so that data packets from a given flow (e.g., a selected flow) can be provided together (i.e., in a batch) to the application processor. In some embodiments, data packets may be temporarily stored in the cache memory until a condition for releasing the data packets is met. In some embodiments, the condition may be a number of data packets from one or more flows or an amount of data stored in the cache reaching a threshold value. In some embodiments, the condition may be a time or duration that data packets have been held in cache memory. In some embodiments, the condition may be a signal received from the application processor. In some embodiments, the condition may depend upon the type of data being carried in a flow or an application executing in the application processor using the data being carried in a flow.

Some embodiments may be implemented in a processor or processors, such as a modem processor, and may use a cache memory within or coupled to the modem. Some embodiments may be implemented in specialized hardware, such as an intermediate packet handling module including a cache memory that is configured to deliver data packets to the application processor in a manner that improves the efficiency and/or accelerates to reception and processing of data packets.

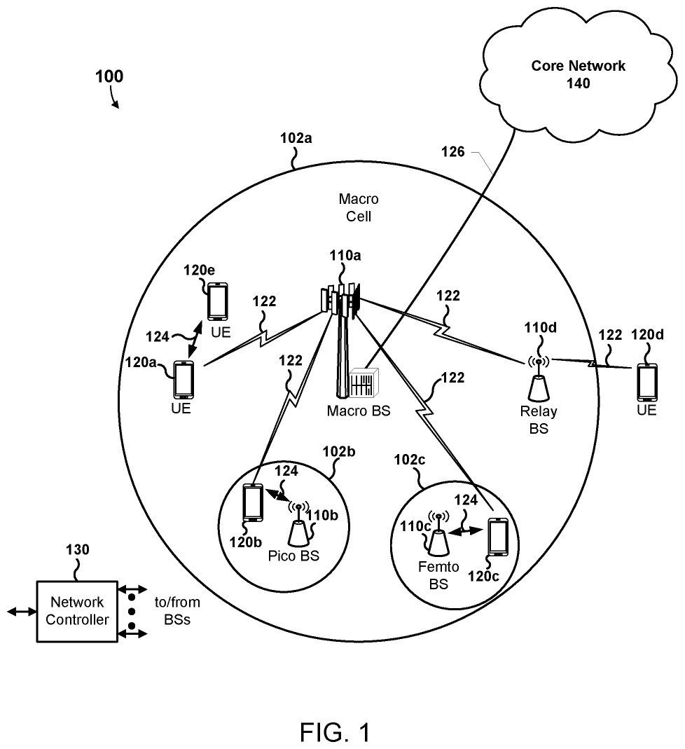

FIG. 1 is a system block diagram illustrating an example communication system 100 suitable for implementing any of the various embodiments. The communications system 100 may be a 5G New Radio (NR) network, or any other suitable network such as a Long Term Evolution (LTE) network.

The communications system 100 may include a heterogeneous network architecture that includes a core network 140 and a variety of mobile devices (illustrated as wireless device 120a-120e in FIG. 1). The communications system 100 may also include a number of base stations (illustrated as the BS 110a, the BS 110b, the BS 110c, and the BS 110d) and other network entities. A base station is an entity that communicates with wireless devices (mobile devices), and also may be referred to as an NodeB, a Node B, an LTE evolved nodeB (eNB), an access point (AP), a radio head, a transmit receive point (TRP), a New Radio base station (NR BS), a 5G NodeB (NB), a Next Generation NodeB (gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by mobile devices with service subscription. A pico cell may cover a relatively small geographic area and may allow unrestricted access by mobile devices with service subscription. A femto cell may cover a relatively small geographic area (for example, a home) and may allow restricted access by mobile devices having association with the femto cell (for example, mobile devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network

The base station 110a-110d may communicate with the core network 140 over a wired or wireless communication link 126. The wireless device 120a-120e may communicate with the base station 110a-110d over a wireless communication link 122.

The wired communication link 126 may use a variety of wired networks (e.g., Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (e.g., relay BS 110d). A relay station is an entity that can receive a transmission of data from an upstream station (for example, a base station or a mobile device) and transmit the data to a downstream station (for example, a wireless device or a base station). A relay station also may be a mobile device that can relay transmissions for other wireless devices. In the example illustrated in FIG. 1, a relay station 110d may communicate with macro the base station 110a and the wireless device 120d in order to facilitate communication between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, etc.

A macro base station 110a may communicate with the communication network 140 over a wired or wireless communication link 126. The wireless devices 120a, 120b, 120c may communicate with a base station 110a-110d over a wireless communication link 122.

The wireless communication links 122, 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links 122, 124 within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some embodiments may use terminology and examples associated with LTE technologies, various embodiments may be applicable to other wireless communications systems, such as a new radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding may also be supported. MIMO configurations in the DL may support up to eight transmit antennas with multi-layer DL transmissions up to eight streams and up to two streams per wireless device. Multi-layer transmissions with up to 2 streams per wireless device may be supported. Aggregation of multiple cells may be supported with up to eight serving cells. Alternatively, NR may support a different air interface, other than an OFDM-based air interface.

Some mobile devices may be considered machine-type communication (MTC) or evolved or enhanced machine-type communication (eMTC) mobile devices. MTC and eMTC mobile devices include, for example, robots, drones, remote devices, sensors, meters, monitors, location tags, etc., that may communicate with a base station, another device (for example, remote device), or some other entity. A wireless node may provide, for example, connectivity for or to a network (for example, a wide area network such as Internet or a cellular network) via a wired or wireless communication link. Some mobile devices may be considered Internet-of-Things (IoT) devices or may be implemented as NB-IoT (narrowband Internet of things) devices. A wireless device 120a-e may be included inside a housing that houses components of the wireless device, such as processor components, memory components, similar components, or a combination thereof.

In general, any number of communication systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, NR or 5G RAT networks may be deployed.

In some implementations, two or more mobile devices 120a-e (for example, illustrated as the wireless device 120a and the wireless device 120e) may communicate directly using one or more sidelink channels 124 (for example, without using a base station 110 as an intermediary to communicate with one another). For example, the wireless devices 120a-e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof In this case, the wireless device 120a-e may perform scheduling operations, resource selection operations, as well as other operations described elsewhere herein as being performed by the base station 110a

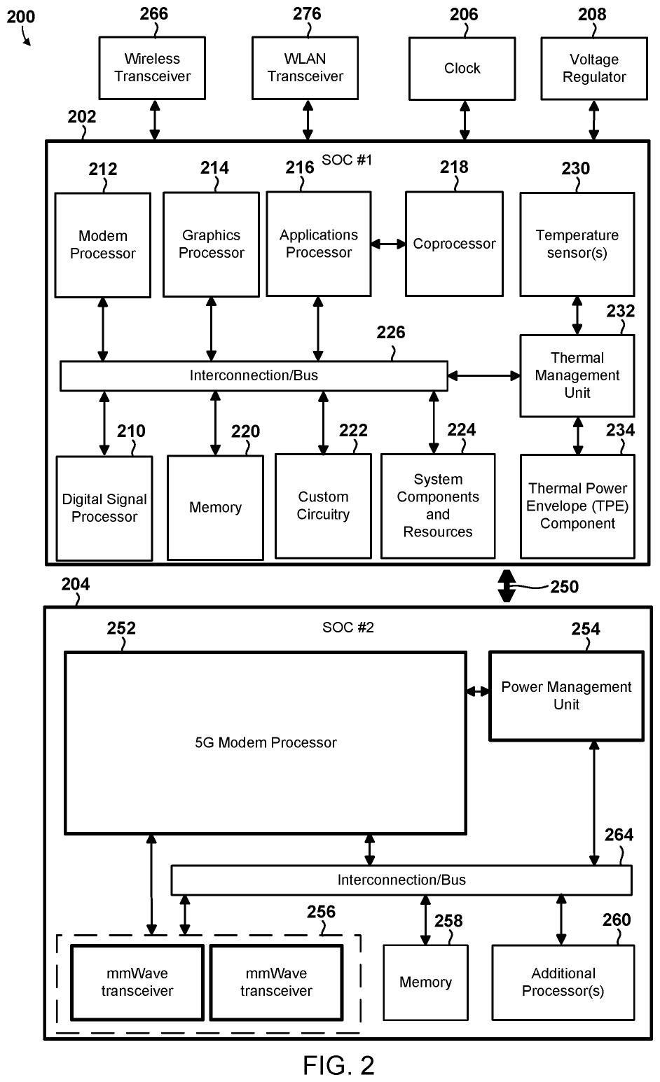

FIG. 2 is a component block diagram illustrating an example computing system 200 suitable for implementing any of the various embodiments. Various embodiments may be implemented on a number of single processor and multiprocessor computer systems, including a system-on-chip (SOC) or system in a package (SIP).

With reference to FIGS. 1 and 2, the illustrated example computing system 200 (which may be a SIP in some embodiments) includes two SOCs 202, 204 coupled to a clock 206, a voltage regulator 208, and a wireless transceiver 266 (e.g., an LTE or 5G transceiver) configured to send and receive wireless communications via an antenna (not shown) to or from a wireless wide area network (WWAN), such as to/from a base station 110a, and a WLAN transceiver 276 (e.g., a WiFi transceiver) configured to send and receive wireless communications via an antenna (not shown) to or from a WLAN, such as to/from a WiFi access point. In some embodiments, the first SOC 202 may operate as central processing unit (CPU) of the wireless device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), as well as very high frequency short wave length (e.g., 28 GHz mmWave spectrum, etc.) communications via one or more mmWave transceivers 256.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuity 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, one or more mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (e.g., clock 206, voltage regulator 208) may be shared by two or more of the internal SOC processors/cores.

In addition to the example SIP 200 discussed above, various embodiments may be implemented in a wide variety of computing systems, which may include a single processor, multiple processors, multicore processors, or any combination thereof.

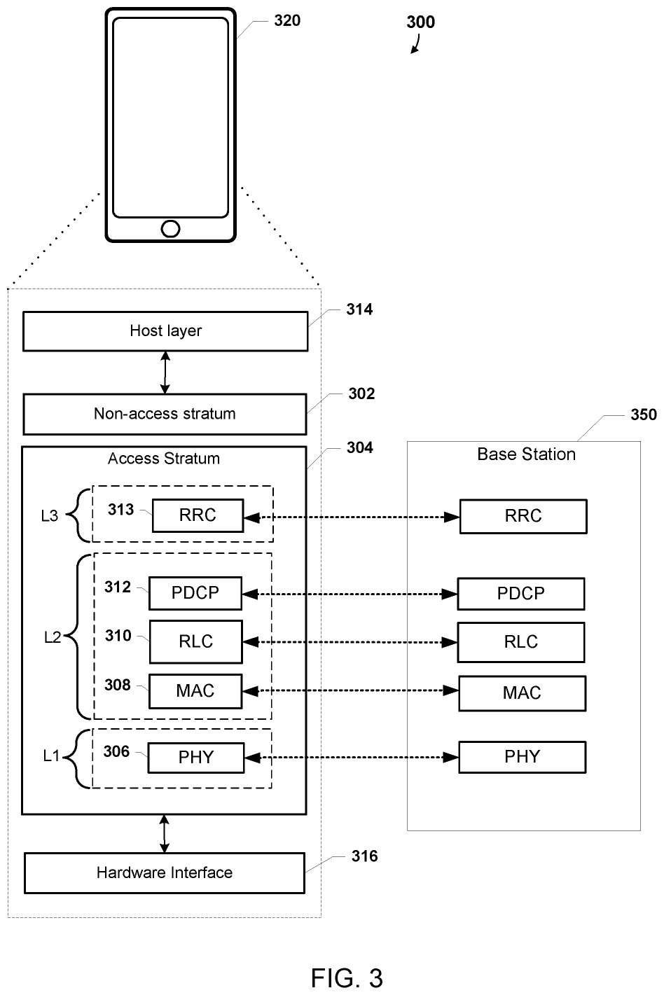

FIG. 3 is a component block diagram illustrating a software architecture 300 including a radio protocol stack for the user and control planes in wireless communications suitable for implementing any of the various embodiments. With reference to FIGS. 1-3, the wireless device 320 may implement the software architecture 300 to facilitate communication between a wireless device 320 (e.g., the wireless device 120a-120e, 200) and the base station 350 (e.g., the base station 110a) of a communication system (e.g., 100). In various embodiments, layers in software architecture 300 may form logical connections with corresponding layers in software of the base station 350. The software architecture 300 may be distributed among one or more processors (e.g., the processors 212, 214, 216, 218, 252, 260). While illustrated with respect to one radio protocol stack, in a multi-SIM (subscriber identity module) wireless device, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the wireless device (e.g., SIM(s) 204) and its core network 140. The AS 304 may include functions and protocols that support communication between a SIM(s) (e.g., SIM(s) 204) and entities of supported access networks (e.g., a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface. Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the wireless device 320 and the base station 350 over the physical layer 306. In the various embodiments, Layer 2 may include a media access control (MAC) sublayer 308, a radio link control (RLC) sublayer 310, and a packet data convergence protocol (PDCP) 312 sublayer, each of which form logical connections terminating at the base station 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In various embodiments, the RRC sublayer 313 may provide functions INCLUDING broadcasting system information, paging, and establishing and releasing an RRC signaling connection between the wireless device 320 and the base station 350.

In various embodiments, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some embodiments, application-specific functions provided by the at least one host layer 314 may provide an interface between the software architecture and the general purpose processor 206.

In other embodiments, the software architecture 300 may include one or more higher logical layer (e.g., transport, session, presentation, application, etc.) that provide host layer functions. For example, in some embodiments, the software architecture 300 may include a network layer (e.g., the Internet protocol (IP) layer) in which a logical connection terminates at a packet data network (PDN) gateway (PGW). In some embodiments, the software architecture 300 may include an application layer in which a logical connection terminates at another device (e.g., end user device, server, etc.). In some embodiments, the software architecture 300 may further include in the AS 304 a hardware interface 316 between the physical layer 306 and the communication hardware (e.g., one or more radio frequency (RF) transceivers).

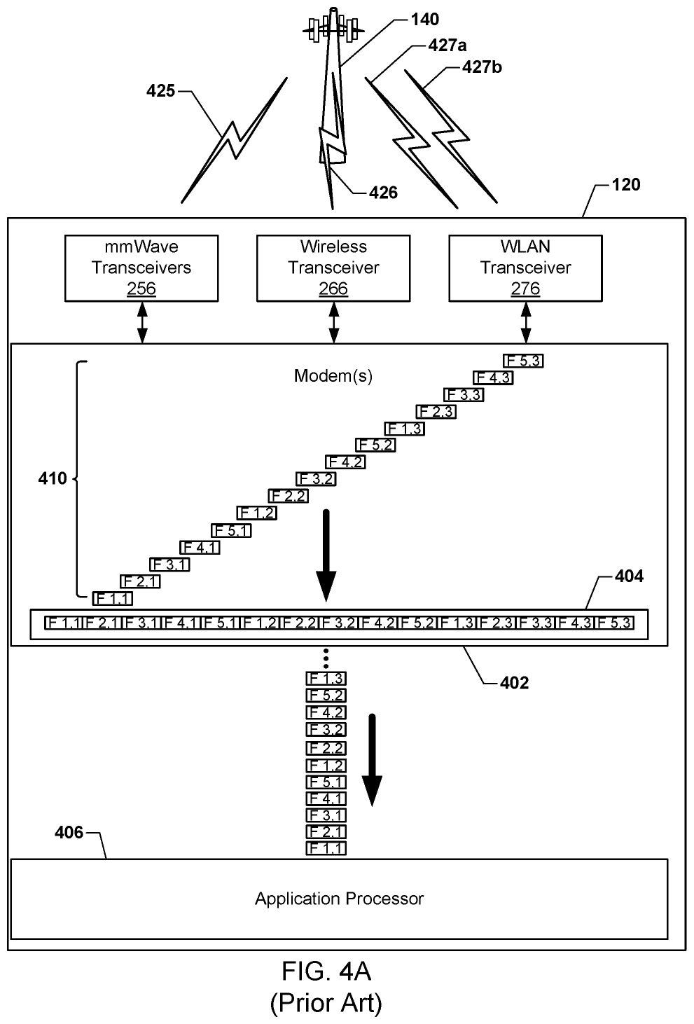

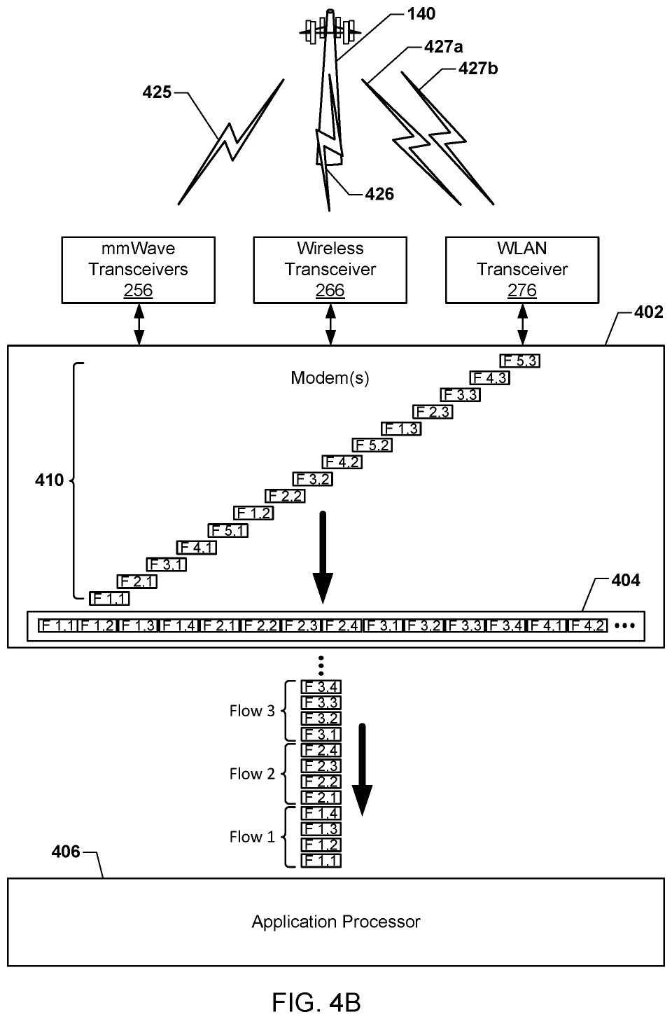

FIG. 4A illustrates how in conventional computing devices received data packets from multiple parallel flows are typically provided by one or more modems 402 to an application processor 406 in the order that the packets are received.

As mentioned above, parallel flows of data packets may be received in a variety of manners from one or more different communication sources or technologies. For example, multiple flows of data packets may be received via a single radio access technology, such as LTE or 5G RAT via transmissions 426 from a base station 110, with the different flows associated with different sockets open to one or more data sources (e.g., one or more remote servers), and via mmWave communication links 425 via a base station 110. Similarly, multiple flows of data packets may be received via a WLAN via WiFi transmissions 427a, 427b from a WiFi access point (not shown), with the different flows associated with different sockets open to one or more data sources accessed via the Internet (e.g., one or more remote servers).

Further, modern wireless devices, such as devices configured for 5G RATs, may maintain multiple different communication links simultaneously using different RATs. In the example illustrated in FIG. 4A, a wireless device 120 may be configured with multiple radios supporting multiple RATs capable of communicating more or less simultaneously, such as a millimeter wave (mmWave) transceiver 256, a wireless transceiver 266 configured to communicate using LTE and/or 5G RATs, and a WLAN transceiver 275 configured to communicate using the 2.5 GHz (427a) and 5 GHz (427b) WiFi frequency bands. These multiple RAT transceivers may be coupled to (or integrated within the same SOC as) one or more modems 402. A wireless device may be capable of receiving data flows from each of the different RAT communication links in parallel, including more than one data flow via different connected sockets on any one RAT communication link.

In the example illustrated in FIG. 4A, five parallel flows (F1-F5) of data packets 410 (individually illustrated as blocks F1,1 through F5,3) are being received in the modem or modems 402 such that the parallel flows are interleaved in time. For example, a first data packet from a first flow (F1,1) is received before a first data packet from a second flow (F2,1), which is received before a first data packet from a third flow (F3,1), and so forth. The illustrated example further shows that once a data packet is received from each parallel flow, the next data packet in each flow is received. For example, reception of data packet F5,1 from the fifth flow precedes reception of the next data packet F1,2 from the first flow, which precedes reception of the next data packet F2,2 from the second flow, and so forth. Said another way, in the illustrated example, data packets are received in the order: F1,1; F2,1; F3,1; F4,1; F5,1; F1,2; F2,2; F3,2; F4,2; F5,2; F1,3; F2,3; F3,3; F4,3; F5,3; F1,4; F2,4; F3,4; F4,4; F5,4; F1,5; F2,51; F3,5; F4,5; F5,5; etc.

Data packets may be temporarily cached in a memory 404 within or coupled to the modem(s) 402 before being passed to the application processor 406 for processing. As noted above, some embodiments may be implemented in specialized hardware, such as an intermediate packet handling module including a cache memory 404 that is configured to deliver data packets to the application processor in a manner that improves the efficiency and/or accelerates to reception and processing of data packets.

As illustrated in FIG. 4A, conventionally data packets may be passed from the modem(s) 402 and/or cache memory 404 to the application processor 406 in the order that the data packets were received. This requires the application processor to store and re-sort (or reorder) data packets as they are received so that data packets for individual flows can be processed together. Further, in order to process a number of data packets from a particular single flow, such as to perform the operations associated with the flow, the application must receive a long sequence of data packets from all flows from the cache memory 404. These required operations of the application processor may increase the power draw by the processor by requiring the processor to be active and requiring more memory operations. Thus, providing data packets in the order received from multiple parallel flows increases the power demand of the application processor.

As illustrated in FIG. 4B, various embodiments include operations to reorder or group together data packets from some or all flows so that batches of data packets from particular flows are provided to the application processor. As illustrated, data packets 410 from the parallel flows may be received in an order that interleaves packets from different flows. However, operations performed by a processor in the modem(s) 402 and/or the cache memory 404 (or specialized hardware for managing the flow of data packets within) result in data packets being passed to the application processor 406 in batches for some or each of the parallel flows. Thus, in the illustrated example, data packets are passed to the application processor 406 in the order F1,1; F1,2; F1,3; F1,4; F2,1; F2,2; F2;3; F2,4; F3,1; F3,2; F3,3; F3,4, etc. This enables the application processor 406 to receive in one batch data packets from a given flow so that operations associated with that flow can be performed on the batch or group of data packets without requiring the application processor 406 to reorder data packets as they are received.

In some embodiments, data packets may be reordered and grouped into batches per flow in the modem or modems 402 and stored in the cache 404 in batch order. In some embodiments, data packets may be passed by the modem or modems 402 to the cache memory 404 in the order received, and processes may be performed to reorder packets in the cache memory 404 into batches for each or selected flow (as illustrated). In some embodiments, data packets may be stored in the cache memory 404 in the order received by the modem or modems 402 but drawn from the cache memory 404 and passed to the application processor 406 in batches for each or some flows. Each of these alternative mechanisms for providing batches of data packets each or some flows to the application processor are encompassed in the claims.

In some embodiments, the ordering of data packets into batches associated with each or some flows may be accomplished using a filter operation implemented in hardware that includes the cache memory 404. In some embodiments, a filter operation implemented in hardware that includes the cache memory 404 may filter data by inspecting the 5 tuple or 3 tuple, TOS (type of service) field attribute.

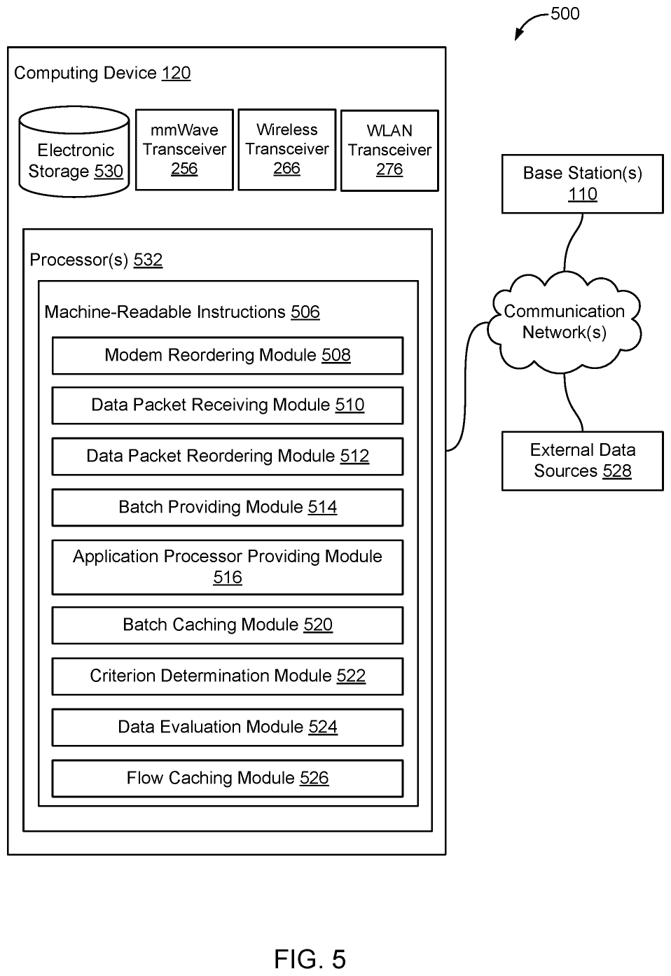

FIG. 5 is a component block diagram illustrating a system 500 configured executed by a processor element for providing data packets from a modem to an application processor in a computing device in accordance with various embodiments. With reference to FIGS. 1-5, the system 500 may include a computing device 120 (e.g., the wireless device 120a-120e, 200, 320), one or more base stations 110 and external resources 528, which may include sources of data (e.g., HD streaming media, online games, etc.) that may be provided to wireless device via a plurality of parallel flows.

The computing device 120 may be configured by machine-readable instructions 506. Machine-readable instructions 506 may include one or more instruction modules. The instruction modules may include computer program modules. The instruction modules may include one or more of a modem reordering module 508, a data packet receiving module 510, a data packet reordering module 512, a batch providing module 514, an application processor providing module 516, a batch caching module 520, a criterion determination module 522, a data evaluation module 524, a flow caching module 526, and/or other instruction modules.

The modem reordering module 508 may be configured to reorder packets received by the modem from a plurality of parallel flows so as to provide to the application processor batches of packets from individual flows within the plurality of parallel flows.

The data packet receiving module 510 may be configured to receive data packets in the plurality of parallel flows, which may include data packets from the flows interleaved in time.

The data packet reordering module 512 may be configured to reorder the received data packets into batches of data packets from individual flows in a cache memory. Data packet reordering module 512 may be configured to reorder the received data packets to form batches of data packets from one or more selected flows among the plurality of parallel flows.

In some embodiments, the batch providing module 514 may be configured to provide the batches of data packets to the application processor one flow at a time. In some embodiments, the batch providing module 514 may be configured to provide the batches of data packets for each of the identified one or more flows to the application processor. In some embodiments, the batch providing module 514 may be configured to provide the batches of data packets for each of the identified one or more flows to the application processor in response to determining that the criterion for releasing the batches of data packets is satisfied. In some embodiments, the batch providing module 514 may be configured to provide the batches of data packets for each of the one or more flows identified for special processing to the application processor. In some embodiments, the batch providing module 514 may be configured to provide the batches of data packets for each of the one or more flows identified for special processing to the application processor in response to determining that the criterion for releasing the batches of data packets is satisfied.

The application processor providing module 516 may be configured to provide to the application processor the batches of data packets from the one or more selected flows and data packets from one or more remaining flows in the plurality of parallel flow in received order.

The batch caching module 520 may be configured to cache data packets received from the identified one or more flows to form batches of data packets for each of the identified one or more flows.

In some embodiments, the criterion determination module 522 may be configured to determine whether a criterion for releasing the one or more flows identified for special processing is satisfied. In some embodiments, the criterion determination module 522 may be configured to determine whether a criterion for releasing the one or more flows identified for special processing is satisfied. As a non-limiting example, the criterion may include one or more of a limit on bytes of data from the identified one or more flows stored in the cache, a limit on a number of data packets from the identified one or more flows stored in the cache, or a limit time that data packets from the identified one or more flows have been stored in the cache. As another non-limiting example, the criterion may include one or more of a limit on bytes of data from the identified one or more flows stored in the cache, a limit on a number of data packets from the identified one or more flows stored in the cache, or a limit time that data packets from the identified one or more flows have been stored in the cache.

The data evaluation module 524 may be configured to evaluate data received in the modem from the plurality of parallel flows to identify one or more flows for special processing involving batching of data packets.

The flow caching module 526 may be configured to cache data packets received from the one or more flows identified for special processing to form batches of data packets for each of the one or more flows identified for special processing.

The computing device 120 may include electronic storage 530, wireless transceivers such as a mmWave transceiver 256, a wireless transceiver 266 (e.g., an LTE or 5G transceiver), and/or a WLAN transceiver 276 (e.g., a WiFi transceiver), one or more processors 532, and/or other components. The illustration of the computing device 120 is not intended to be limiting, because the computing device 120 may include a plurality of hardware, software, and/or firmware components operating together to provide the functionality described herein.

The electronic storage 530 may include non-transitory storage media that electronically stores information. The electronic storage media of electronic storage 530 may include one or both of system storage that is provided integrally (i.e., substantially non-removable) with computing device 120 and/or removable storage that is removably connectable to the computing device 120 via, for example, a SIM card, a port (e.g., a universal serial bus (USB) port, a firewire port, etc.) or a drive (e.g., a disk drive, etc.). Electronic storage 530 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 530 may store software algorithms, information determined by processor(s) 532, information received from computing platform(s) 502, information received from remote platform(s) 504, and/or other information that enables computing device 120 to function as described herein.

The processor(s) 532 may be configured to provide information processing capabilities in computing platform(s) 502. As such, the processor(s) 532 may include one or more of a digital processor, an analog processor, a digital circuit designed to process information, an analog circuit designed to process information, a state machine, and/or other mechanisms for electronically processing information. Although the processor(s) 532 is illustrated as a single entity, this is for illustrative purposes only. In some embodiments, the processor(s) 532 may include a plurality of processing units and/or processor cores. The processor(s) 532 may be configured to execute modules 508, 510, 512, 514, 516, 518, 520, 522, 524, and/or 526 and/or other modules by software; hardware; firmware; some combination of software, hardware, and/or firmware; and/or other mechanisms for configuring processing capabilities on processor(s) 532. As used herein, the term “module” may refer to any component or set of components that perform the functionality attributed to the module. This may include one or more physical processors during execution of processor readable instructions, the processor readable instructions, circuitry, hardware, storage media, or any other components.

The description of the functionality provided by the different modules 508, 510, 512, 514, 516, 518, 520, 522, 524, and/or 526 is for illustrative purposes, and is not intended to be limiting, as any of modules 508, 510, 512, 514, 516, 518, 520, 522, 524, and/or 526 may provide more or less functionality than is described. For example, one or more of the modules 508, 510, 512, 514, 516, 518, 520, 522, 524, and/or 526 may be eliminated, and some or all of its functionality may be provided by other modules 508, 510, 512, 514, 516, 518, 520, 522, 524, and/or 526. As another example, the processor(s) 532 may be configured to execute one or more additional modules that may perform some or all of the functionality attributed below to one of the modules 508, 510, 512, 514, 516, 518, 520, 522, 524, and/or 526.

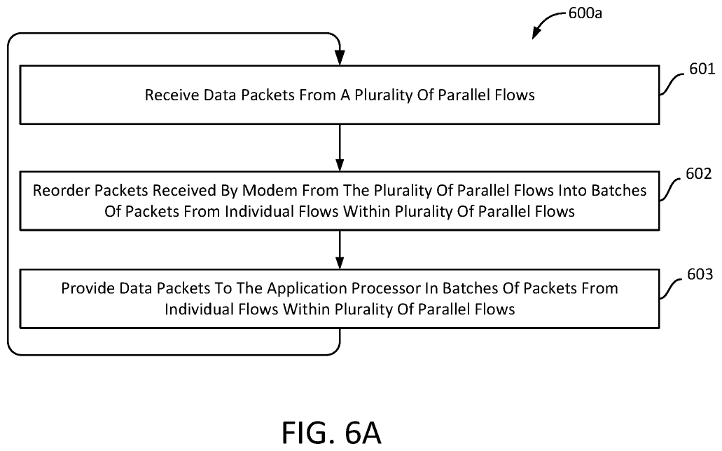

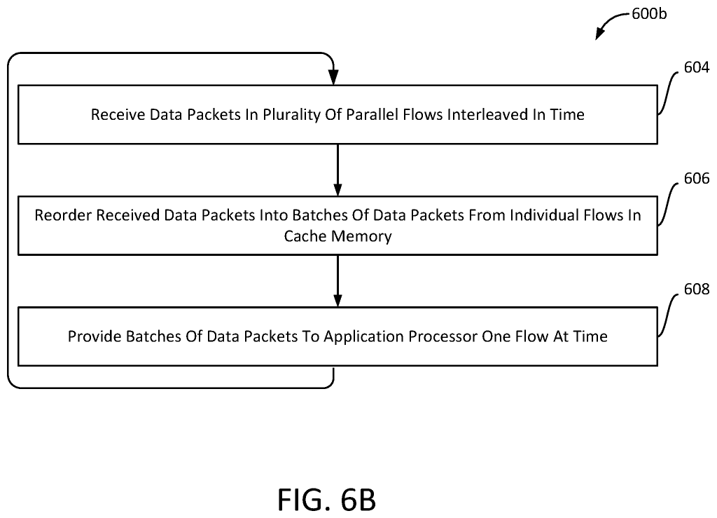

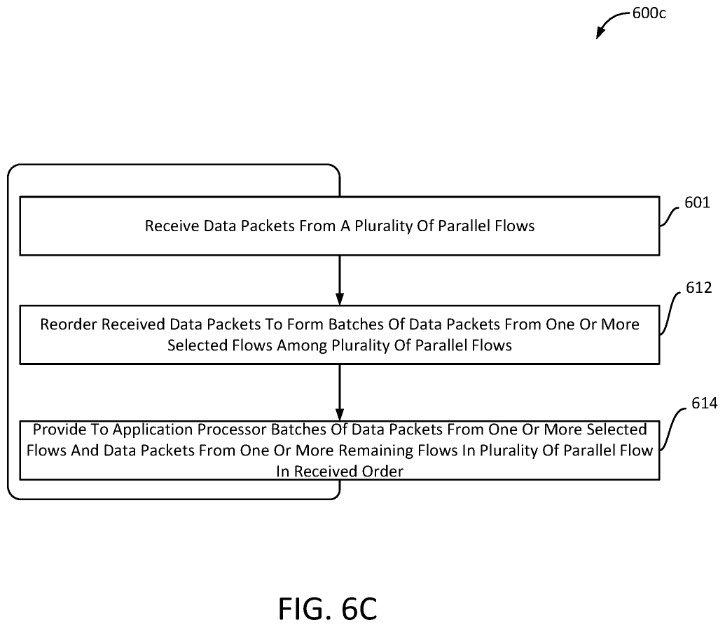

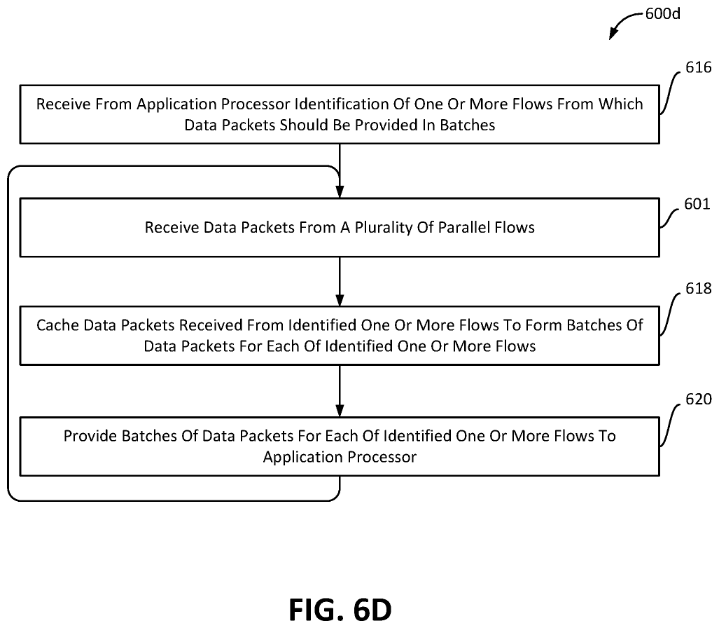

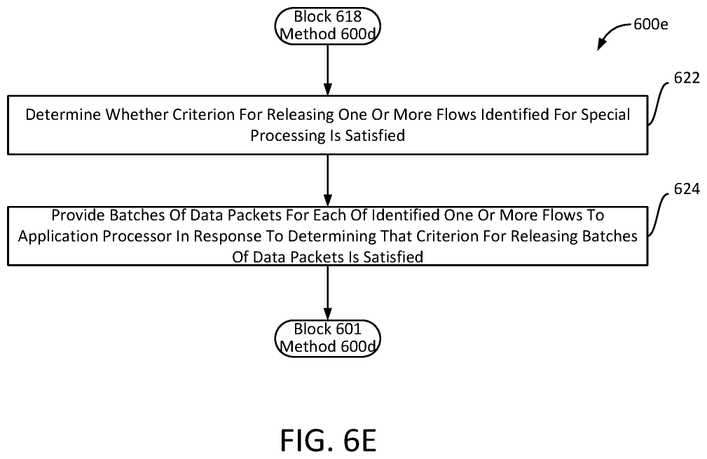

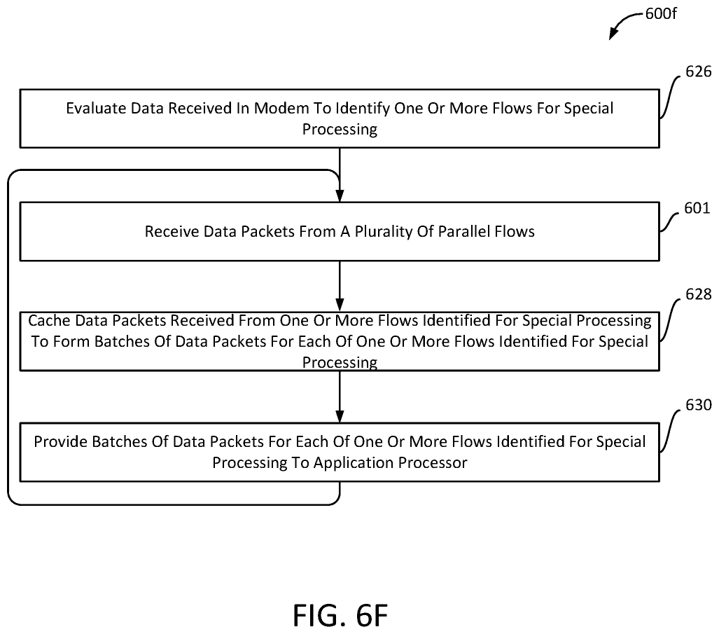

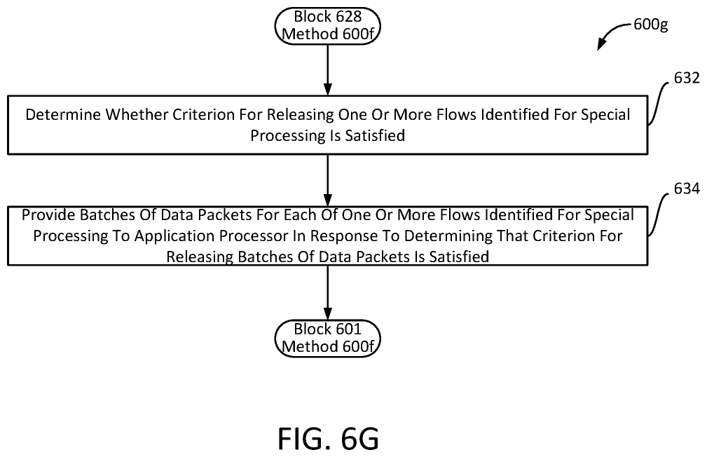

FIGS. 6A, 6B, 6C, 6D, 6E, 6F, and 6G illustrate operations of methods 600a-600g that may be executed by a processor element of a computing device for providing data packets that are received from a plurality of parallel flows to an application processor in the computing device in accordance with various embodiments. In some embodiments the operations in the methods 600a-600g may be performed by a modem or modems (e.g., 402) and a processing element (e.g., 404) that may include a cache memory. In some embodiments, the processing element may be implemented as part of the functionality of the modem or modems. In some embodiments, the processing element may be a hardware element within the modem or modems. In some embodiments, the processing element may be separate processing and memory hardware element coupled to the modem or modems and to the application processor. In some embodiments, the processing element may be implemented partially in hardware and partially in software executing in a processor (e.g., a modem processor). To encompass all alternative configurations, the methods 600a-600g are described using the general term “processing element.”

The operations of methods 600a-600g are intended to be illustrative. In some embodiments, the methods 600a-600g may be accomplished with one or more additional operations not described, and/or without one or more of the operations discussed. Additionally, the order in which the operations of the methods 600a-600g are illustrated in FIGS. 6A, 6B, 6C, 6D, 6E, 6F, and/or 6G and described is not intended to be limiting.

FIG. 6A is a process flow diagram illustrate operations of a method 600a in accordance with some embodiments.

In block 601, the processing element may receive data packets from a plurality of parallel flows. As described, parallel flows of data packets may be received from a single communication source via multiple open sockets, from multiple communication links via multiple communication technologies (e.g., LTE, 5G, NR, WiFi), and/or multiple communication links some with multiple open sockets. Means for performing functions of the operations in block 601 may include the processing element (e.g., 202, 204, 404) within or coupled to a modem or modems (e.g., 212, 252,402) coupled to one or more wireless transceivers (e.g., 256, 266, 276).

In block 602, the processing element may perform operations including reordering packets received by the modem from a plurality of parallel flows into batches of packets from individual flows within the plurality of parallel flows. Means for performing functions of the operations in block 601 may include the processing element (e.g., 202, 204, 404) within or coupled to a modem or modems (e.g., 212, 252, 402).

In block 603, the processing element may perform operations including providing data packets to the application processor in batches of packets from individual flows within the plurality of parallel flows. Means for performing functions of the operations in block 601 may include the processing element (e.g., 202, 204, 404).

The operations in the method 600a may be performed repetitively and continuously while data packets are received from a plurality of parallel data flows.

FIG. 6B is a process flow diagram illustrate operations of a method 600b in accordance with some embodiments.

In block 604, the processing element may perform operations including receiving data packets in the plurality of parallel flows interleaved in time. Similar to the operations in block 601 as described with reference to FIG. 6A, parallel flows of data packets may be received from a single communication source via multiple open sockets, from multiple communication links via multiple communication technologies (e.g., LTE, 5G, NR, WiFi), and/or multiple communication links some with multiple open sockets. For example, the parallel flows of data packets may be received such that a data packet is received from each parallel flow within the interval between data packets on any one flow. Means for performing functions of the operations in block 604 may include the processing element (e.g., 202, 204, 404) within or coupled to a modem or modems (e.g., 212, 252, 402) coupled to one or more transceivers (e.g., 256, 266, 276).

In block 606, the processing element may perform operations including reordering the received data packets into batches of data packets from individual flows in a cache memory. In some embodiments, rather than storing the data packets in receive order per flow, the processing element may store metadata that will enable the processing element to deliver data packets to the application processor in batches for each flow. Means for performing functions of the operations in block 606 may include the processing element (e.g., 202, 204, 404) within or coupled to a modem or modems (e.g., 212, 252, 402).

In block 608, the processing element may perform operations including providing the batches of data packets to the application processing element one flow at a time. Means for performing functions of the operations in block 608 may include the processing element (e.g., 202, 204, 404) within or coupled to a modem or modems (e.g., 212, 252,402).

The operations in the method 600b may be performed repetitively and continuously while data packets are received from a plurality of parallel data flows.

FIG. 6C is a process flow diagram illustrate operations of a method 600c in accordance with some embodiments.

In block 601, the processing element may perform operations including receiving data packets in the plurality of parallel flows as described.

In block 612, the processing element may perform operations including reordering the received data packets to form batches of data packets from one or more selected flows among the plurality of parallel flows. In some embodiments, the selected flows may be pre-defined, such as based on the source (e.g., RAT) of the data packets. Similar to the operations in blocks 606 and 618, the processing element may reorder the received data packets from the selected flow or flows into batches of data packets from individual flows stored in a cache memory or store metadata that will enable the processing element to deliver data packets to the application processor in batches for each selected flow. Means for performing functions of the operations in block 612 may include the processing element (e.g., 202, 204, 404) within or coupled to a modem or modems (e.g., 212, 252, 402).

In block 614, the processing element may perform operations including providing to the application processing element the batches of data packets from the one or more selected flows and data packets from one or more remaining flows in the plurality of parallel flow in received order.

The operations in the method 600c may be performed repetitively and continuously while data packets are received from a plurality of parallel data flows.

FIG. 6D is a process flow diagram illustrate operations of a method 600d in accordance with some embodiments.

In block 616, the processing element may perform operations including receiving from an application processing element an identification of one or more flows from which data packets should be provided in batches. For example, the processor may identify to the processing element flows for which receiving data packets in batches will improve the efficiency of the application processor and/or processing data packets.

In block 601, the processing element may perform operations including receiving data packets in the plurality of parallel flows as described.

In block 618, the processing element may perform operations including caching data packets received from the identified one or more flows to form batches of data packets for each of the identified one or more flows. Similar to the operations in blocks 606 and 618, the processing element may reorder the received data packets from the identified flow or flows into batches of data packets from individual flows stored in a cache memory or store metadata that will enable the processing element to deliver data packets to the application processor in batches for each identified flow. Means for performing functions of the operations in block 612 may include the processing element (e.g., 202, 204, 404) within or coupled to a modem or modems (e.g., 212, 252, 402).

In block 620, the processing element may perform operations including providing the batches of data packets for each of the identified one or more flows to the application processing element.

The operations in the method 600d may be performed repetitively and continuously while data packets are received from a plurality of parallel data flows.

FIG. 6E is a process flow diagram illustrate operations of a method 600e, which includes operations of the method 600d in accordance with some embodiments.

In block 622, the processing element may perform operations including determining whether a criterion for releasing the one or more flows identified for special processing is satisfied. In some embodiments, the application processor may identify the criterion for releasing batches of data packets from one or more flows. In some embodiments, the criterion may include one or more of a limit on bytes of data from the identified one or more flows stored in the cache, a limit on a number of data packets from the identified one or more flows stored in the cache, or a limit time that data packets from the identified one or more flows have been stored in the cache. In some embodiments, the criterion may include one or more of a limit on bytes of data from the identified one or more flows stored in the cache, a limit on a number of data packets from the identified one or more flows stored in the cache, or a limit time that data packets from the identified one or more flows have been stored in the cache

In block 624, the processing element may perform operations including providing the batches of data packets for each of the identified one or more flows to the application processing element in response to determining that the criterion for releasing the batches of data packets is satisfied.

FIG. 6F is a process flow diagram illustrate operations of a method 600f in accordance with some embodiments.

In block 626, the processing element may perform operations including evaluating data received in the modem to identify one or more flows for special processing.

In block 601, the processing element may perform operations including receiving data packets in the plurality of parallel flows as described.

In block 628, the processing element may perform operations including caching data packets received from the one or more flows identified for special processing to form batches of data packets for each of the one or more flows identified for special processing. Similar to the operations in blocks 606 and 618, the processing element may reorder the received data packets from the identified flow or flows into batches of data packets from individual flows stored in a cache memory or store metadata that will enable the processing element to deliver data packets to the application processor in batches for each identified flow. Means for performing functions of the operations in block 612 may include the processing element (e.g., 202, 204, 404) within or coupled to a modem or modems (e.g., 212, 252,402).

In block 630, the processing element may perform operations including providing the batches of data packets for each of the one or more flows identified for special processing to the application processing element.

The operations in the method 600f may be performed repetitively and continuously while data packets are received from a plurality of parallel data flows.

FIG. 6G is a process flow diagram illustrate operations of a method 600g, which includes operations of the method 600d in accordance with some embodiments.

In block 632, the processing element may perform operations including determining whether a criterion for releasing the one or more flows identified for special processing is satisfied. In some embodiments, the criterion may include one or more of a limit on bytes of data from the identified one or more flows stored in the cache, a limit on a number of data packets from the identified one or more flows stored in the cache, or a limit time that data packets from the identified one or more flows have been stored in the cache. In some embodiments, the criterion may include one or more of a limit on bytes of data from the identified one or more flows stored in the cache, a limit on a number of data packets from the identified one or more flows stored in the cache, or a limit time that data packets from the identified one or more flows have been stored in the cache.

In block 634, the processing element may perform operations including providing the batches of data packets for each of the one or more flows identified for special processing to the application processing element in response to determining that the criterion for releasing the batches of data packets is satisfied.

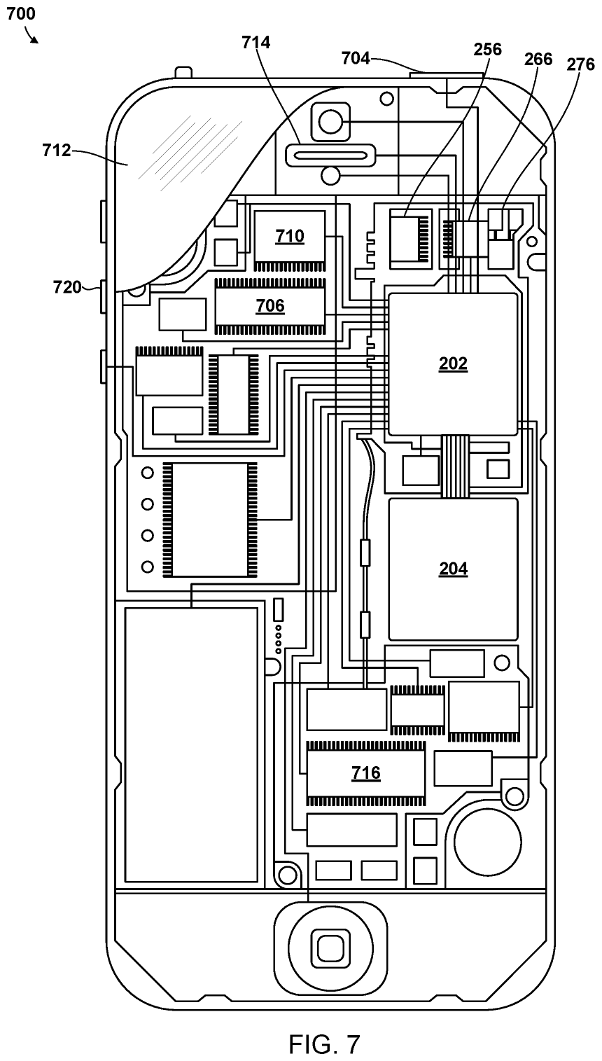

FIG. 7 is a component block diagram of a wireless device 700 suitable for use with various embodiments. With reference to FIGS. 1-7, various embodiments may be implemented on a variety of wireless devices (e.g., the wireless device 120a-120e, 200, 320, 502), an example of which is illustrated in FIG. 7 in the form of a smartphone. The wireless device 700 may include a first SOC 202 (e.g., a SOC-CPU) coupled to a second SOC 204 (e.g., a 5G capable SOC). The first and second SOCs 202, 204 may be coupled to internal memory 706, 716, a display 712, and to a speaker 714. Additionally, the wireless device 700 may include an antenna 704 for sending and receiving electromagnetic radiation that may be connected to a wireless data link and/or cellular telephone transceiver 266, WiFi transceiver 276 and mmWave transceiver 256 coupled to one or more processors in the first and/or second SOCs 202, 204. The wireless device 700 may also include menu selection buttons or rocker switches 720 for receiving user inputs.

The wireless device 700 also includes a sound encoding/decoding (CODEC) circuit 710, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 708 and CODEC 710 may include a digital signal processor (DSP) circuit (not shown separately).

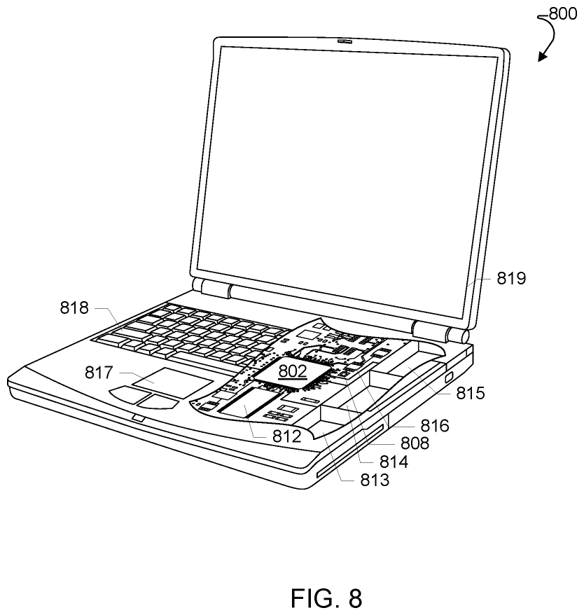

Methods and devices for implementing such methods in accordance with the various embodiments (including, but not limited to, embodiments described above with reference to FIGS. 1-6G) may be implemented in a wide variety of computing systems include a laptop computer 800 an example of which is illustrated in FIG. 8. A laptop computer 800 will typically include a processor 802 coupled to volatile memory 812 and a large capacity nonvolatile memory, such as a compact disc (CD) drive 813 or Flash memory. Additionally, the computer 800 may have one or more antenna 808 for sending and receiving electromagnetic radiation that may be connected to a wireless data link and/or cellular telephone transceiver 816 coupled to the processor 802. The computer 800 may also include a floppy disc drive 814 and a CD drive 813 coupled to the processor 802. In a notebook configuration, the computer housing may include a battery 815, a touchpad touch surface 817 that serves as the computer's pointing device, a keyboard 818, and a display 819 all coupled to the processor 802. Other configurations of the computing device may include a computer mouse or trackball coupled to the processor (e.g., via a USB input) as are well known, which may also be used in conjunction with the various embodiments.

The processors of the wireless device 700 and the laptop computer 800 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor within an SOC 204 dedicated to wireless communication functions and one processor within an SOC 202 dedicated to running other applications. Software applications may be stored in the memory 706, 716, 812 before they are accessed and loaded into the processor. The processors may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless device and the wireless device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method executed by a processor element for providing data packets from a modem to an application processor in a computing device, comprising:
reordering packets received by the modem from a plurality of parallel flows so as to provide to the application processor batches of packets from individual flows within the plurality of parallel flows.

2. The method of claim 1, wherein reordering packets received by the modem from a plurality of parallel flows so as to provide to the application processor batches of packets from individual flows within the plurality of parallel flows comprises:
receiving data packets in the plurality of parallel flows interleaved in time;
reordering the received data packets into batches of data packets from individual flows in a cache memory; and
providing the batches of data packets to the application processor one flow at a time.

3. The method of claim 1, wherein reordering packets received by the modem from a plurality of parallel flows so as to provide to the application processor batches of packets from individual flows within the plurality of parallel flows comprises:
receiving data packets in the plurality of parallel flows;
reordering the received data packets to form batches of data packets from one or more selected flows among the plurality of parallel flows; and
providing the batches of data packets from the one or more selected flows to the application processor and providing data packets from one or more remaining flows in the plurality of parallel flows to the application processor in received order.

4. The method of claim 1, further comprising:
receiving from the application processor an identification of one or more flows from which data packets should be provided in batches,
wherein reordering packets received by the modem from a plurality of parallel flows so as to provide to the application processor batches of packets from individual flows within the plurality of parallel flows comprises:
caching data packets received from the identified one or more flows to form batches of data packets for each of the identified one or more flows; and
providing the batches of data packets for each of the identified one or more flows to the application processor.

5. The method of claim 4, further comprising determining whether a criterion for releasing the one or more flows identified for special processing is satisfied,
wherein providing the batches of data packets for each of the identified one or more flows to the application processor comprises providing the batches of data packets for each of the identified one or more flows to the application processor in response to determining that the criterion for releasing the batches of data packets is satisfied.

6. The method of claim 5, wherein the criterion comprises one or more of a criterion received from the application processor, a limit on bytes of data from the identified one or more flows stored in a cache memory, a limit on a number of data packets from the identified one or more flows stored in the cache memory, or a limit time that data packets from the identified one or more flows have been stored in the cache memory.

7. The method of claim 1, further comprising evaluating data received in the modem to identify one or more flows for special processing,
wherein reordering packets received by the modem from a plurality of parallel flows so as to provide to the application processor batches of packets from individual flows within the plurality of parallel flows comprises:
caching data packets received from the one or more flows identified for special processing to form batches of data packets for each of the one or more flows identified for special processing; and
providing the batches of data packets for each of the one or more flows identified for special processing to the application processor.

8. The method of claim 7, further comprising determining whether a criterion for releasing the one or more flows identified for special processing is satisfied,
wherein providing the batches of data packets for each of the one or more flows identified for special processing to the application processor comprises providing the batches of data packets for each of the one or more flows identified for special processing to the application processor in response to determining that the criterion for releasing the batches of data packets is satisfied.

9. The method of claim 8, wherein the criterion comprises one or more of a limit on bytes of data from the identified one or more flows stored in a cache memory, a limit on a number of data packets from the identified one or more flows stored in the cache memory, or a limit time that data packets from the identified one or more flows have been stored in the cache memory.

10. A computing device, comprising:
a memory;
a modem;
an application processor; and
a processing element coupled to the memory, the modem and the application processor, wherein the processing element is configured to:
reorder packets received by the modem from a plurality of parallel flows so as to provide to the application processor batches of packets from individual flows within the plurality of parallel flows.

11. The computing device of claim 10, wherein the processing element is further configured to reorder packets received by the modem from a plurality of parallel flows so as to provide to the application processor batches of packets from individual flows within the plurality of parallel flows by:
receiving data packets in the plurality of parallel flows interleaved in time;
reordering the received data packets into batches of data packets from individual flows in the memory; and
providing the batches of data packets to the application processor one flow at a time.

12. The computing device of claim 10, wherein the processing element is further configured to reorder packets received by the modem from a plurality of parallel flows so as to provide to the application processor batches of packets from individual flows within the plurality of parallel flows by:
receiving data packets in the plurality of parallel flows;
reordering the received data packets to form batches of data packets from one or more selected flows among the plurality of parallel flows; and
providing the batches of data packets from the one or more selected flows to the application processor and providing data packets from one or more remaining flows in the plurality of parallel flows to the application processor in received order.

13. The computing device of claim 10, wherein the processing element is further configured to receive from the application processor an identification of one or more flows from which data packets should be provided in batches,
wherein the processing element is further configured to reorder packets received by the modem from a plurality of parallel flows so as to provide to the application processor batches of packets from individual flows within the plurality of parallel flows by:
caching data packets received from the identified one or more flows to form batches of data packets for each of the identified one or more flows; and
providing the batches of data packets for each of the identified one or more flows to the application processor.

14. The computing device of claim 13, wherein the processing element is further configured to determine whether a criterion for releasing the one or more flows identified for special processing is satisfied,
wherein the processing element is further configured to provide the batches of data packets for each of the identified one or more flows to the application processor comprises providing the batches of data packets for each of the identified one or more flows to the application processor in response to determining that the criterion for releasing the batches of data packets is satisfied.

15. The computing device of claim 14, wherein the criterion comprises one or more of a criterion received from the application processor, a limit on bytes of data from the identified one or more flows stored in the memory, a limit on a number of data packets from the identified one or more flows stored in the memory, or a limit time that data packets from the identified one or more flows have been stored in the memory.

16. The computing device of claim 10, wherein the processing element is further configured to evaluate data received in the modem to identify one or more flows for special processing,
wherein the processing element is further configured to reorder packets received by the modem from a plurality of parallel flows so as to provide to the application processor batches of packets from individual flows within the plurality of parallel flows by:
caching data packets received from the one or more flows identified for special processing to form batches of data packets for each of the one or more flows identified for special processing; and
providing the batches of data packets for each of the one or more flows identified for special processing to the application processor.

17. The computing device of claim 16, wherein the processing element is further configured to determine whether a criterion for releasing the one or more flows identified for special processing is satisfied,
wherein the processing element is further configured to provide the batches of data packets for each of the one or more flows identified for special processing to the application processor comprises providing the batches of data packets for each of the one or more flows identified for special processing to the application processor in response to determining that the criterion for releasing the batches of data packets is satisfied.

18. The computing device of claim 17, wherein the criterion comprises one or more of a limit on bytes of data from the identified one or more flows stored in the memory, a limit on a number of data packets from the identified one or more flows stored in the memory, or a limit time that data packets from the identified one or more flows have been stored in the memory.

19. A modem, comprising:
a memory; and
a processing device coupled to the memory and configured to reorder packets received by the modem from a plurality of parallel flows so as to provide to an application processor batches of packets from individual flows within the plurality of parallel flows.

20. The modem of claim 19, wherein the processing element is further configured to reorder packets received by the modem from a plurality of parallel flows so as to provide to the application processor batches of packets from individual flows within the plurality of parallel flows by:
receiving data packets in the plurality of parallel flows interleaved in time;
reordering the received data packets into batches of data packets from individual flows in a cache memory; and
providing the batches of data packets to the application processor one flow at a time.

21. The modem of claim 19, wherein the processing element is further configured to reorder packets received by the modem from a plurality of parallel flows so as to provide to the application processor batches of packets from individual flows within the plurality of parallel flows by:
receiving data packets in the plurality of parallel flows;
reordering the received data packets to form batches of data packets from one or more selected flows among the plurality of parallel flows; and
providing the batches of data packets from the one or more selected flows to the application processor and providing data packets from one or more remaining flows in the plurality of parallel flows to the application processor in received order.

22. The modem of claim 19, wherein the processing element is further configured to receive from the application processor an identification of one or more flows from which data packets should be provided in batches,
wherein the processing element is further configured to reorder packets received by the modem from a plurality of parallel flows so as to provide to the application processor batches of packets from individual flows within the plurality of parallel flows by:
caching data packets received from the identified one or more flows to form batches of data packets for each of the identified one or more flows; and
providing the batches of data packets for each of the identified one or more flows to the application processor.

23. The modem of claim 22, wherein the processing element is further configured to determine whether a criterion for releasing the one or more flows identified for special processing is satisfied,
wherein the processing element is further configured to provide the batches of data packets for each of the identified one or more flows to the application processor comprises providing the batches of data packets for each of the identified one or more flows to the application processor in response to determining that the criterion for releasing the batches of data packets is satisfied.

24. The modem of claim 23, wherein the criterion comprises one or more of a criterion received from the application processor, a limit on bytes of data from the identified one or more flows stored in the cache, a limit on a number of data packets from the identified one or more flows stored in the cache, or a limit time that data packets from the identified one or more flows have been stored in the cache.

25. The modem of claim 19, wherein the processing element is further configured to evaluate data received in the modem to identify one or more flows for special processing,
wherein the processing element is further configured to reorder packets received by the modem from a plurality of parallel flows so as to provide to the application processor batches of packets from individual flows within the plurality of parallel flows by:
caching data packets received from the one or more flows identified for special processing to form batches of data packets for each of the one or more flows identified for special processing; and
providing the batches of data packets for each of the one or more flows identified for special processing to the application processor.

26. The modem of claim 25, wherein the processing element is further configured to determine whether a criterion for releasing the one or more flows identified for special processing is satisfied,
wherein the processing element is further configured to provide the batches of data packets for each of the one or more flows identified for special processing to the application processor comprises providing the batches of data packets for each of the one or more flows identified for special processing to the application processor in response to determining that the criterion for releasing the batches of data packets is satisfied.

27. The modem of claim 26, wherein the criterion comprises one or more of a limit on bytes of data from the identified one or more flows stored in the cache, a limit on a number of data packets from the identified one or more flows stored in the cache, or a limit time that data packets from the identified one or more flows have been stored in the cache.
